(19) United States
(12) Patent Application Publication
(10) Pub. No.: US 2003/0120562 A1
(43) Pub. Date: Jun. 26, 2003

(54) Retail advertising method

(76) Inventors: Jeffery L. Clark, Wilmington, NC (US); Jonathan P. Siembor, Andover, OH (US)

Correspondence Address: WILLIAM J. MASON, MACCORD MASON PLLC, POST OFFICE BOX 1489, WRIGHTSVILLE BEACH, NC, 28480, US

(21) Appl. No.: 10/364,264

(22) Filed: Feb. 11, 2003

Related U.S. Application Data
(63) Continuation-in-part of application No. 09/919,652, filed on Jul. 31, 2001.

(51) Int. Cl. G06F 17/60

(52) U.S. Cl. 705/27

(57) ABSTRACT

A method is described for advertising selected products to prospective purchasers in a retail establishment having at least one checkout terminal with a monitor screen viewable by prospective customers. Advertising materials for products to be advertised are compiled as an electronic database that is displayed within at least one graphical field on the monitor screen, or a plurality of monitor screens, whenever at least one graphical field is otherwise inactive.

This is a CIP of application Ser. No. 09/919,652 filed Jul. 31, 2001.

### BACKGROUND OF THE INVENTION

(1) Field of the Invention

The present invention relates generally to a method for advertising in retail establishments and in particular to a method for displaying selected electronic information and advertisements viewable to prospective buyers when entering the establishment, or when in the establishment.

(2) Description of the Prior Art

Product suppliers, in particular consumer goods manufacturers whose products are sold through supermarkets and other retail establishments or stores, often enter into advertising agreements with the store, or with a group of commonly owned stores in which the store agrees to advertise the manufacturer's products. Such agreements are used in particular with consumer-packaged goods, i.e., products packaged in cans, cartons or other containers by the manufacturer.

For example, supermarkets may prepare weekly newspaper inserts to advertise products that are on sale during a given week. These leaflets and other advertising media employed by supermarkets are often expensive, offer a limited number of goods, and require advance notification by the manufacturer of products to be advertised. Similar programs are used in other retail establishments, including department, specialty, automotive, and hardware stores. As used herein, the term “advertisements,” while particularly including product depictions, such as photographs or graphical images, is also intended to include all types of product information that a supplier wishes to advertise to prospective customers.

Perhaps of major importance is the fact that such advertisements are received by the prospective customer at home or at another non-store location, often one or more days before the customer may actually come to the retail establishment or store. As a result, unless the sales material is brought to the store, the customer may not recall that particular items are on sale.

Stores may also use point-of-sale materials such as in-store signage to advise the prospective customer of on-sale items. However, in-store signage is expensive to prepare, install, and later remove. Also, only a limited amount of in-store advertising material can be placed at a given retail location before the shopping area becomes cluttered.

Thus, there is a continuing need for a way to acquaint prospective customers with new and on-sale items, or to further justify the innovative issues regarding this invention, to advertise “On Sale Next Week”. In particular there is a need for advertising such items in an in-store or on-premises manner so that the prospective customer will be exposed to the advertisement at the time of the purchase opportunity. There is especially a need for a method of this type of advertising that can be conducted economically and which will enable the retailer to quickly make changes in the advertisements.

### SUMMARY OF THE INVENTION

For the purpose of this application, a graphical field is defined as a region on a video monitor screen within which presentation graphics are displayed. The graphical field may take up the entire screen at one time as with a screen saver or it may take up only a portion of the screen similar to an Internet “pop-up” ad or graphical users interface (GUI) toolbar, etc.

The graphical field may be any geometric shape or may be amorphous such as a graphic that progressively blends into a background. The graphical field may have static or dynamic dimensions. An example of a graphical field with dynamic dimensions would be a rotating rectangle. Moreover, the graphical field can have either a static or dynamic position. An example of a graphical field having a dynamic position would be one involving animation such as a moving marquee, etc. Furthermore, the presentation graphics may have a plurality of graphical fields per video screen. Also, the allocation of graphical fields to a particular screen may be dynamic in a way that frees up any number of graphical fields for other applications that may take priority. On the other hand, a sequence of presentation graphics may reoccupy relinquished graphical fields as they become available due to a priority application closing, etc.

The presentation graphics displayed in a graphical field may be text or graphic images. The text may be alphanumeric characters or any symbols portraying information to a reader. The graphic images may be digital photographs, video or graphic artwork such as logos for products. The presentation graphics displayed within a graphics field may also be a combination of text and images. In the case of a monochrome video screen, the presentation graphics may be black or white or levels of grayscale. On the other hand, if the video monitor screen is color, the presentation graphics can be any color or combination of colors that the video monitor is capable of displaying.

In modern retail establishments such as supermarkets, checkout lanes or counters are provided for use by customers in paying for selected merchandise. While historically these checkout lanes included a cash register to total the price of the goods purchased, modern checkout lanes use a computer terminal with a monitor and a means for scanning bar codes carried by the goods. While the terminal can include a keyboard or keypad for use by the operator, entries at many terminals are now made, at least in part, by the use of touch screens, with various commands being entered by touching images on the monitor screen.

In addition, many retail establishments, in particular supermarkets, now have self-service checkout lanes in which the store operator oversees a plurality of checkout lanes. Each checkout lane includes a customer-operated checkout terminal with a monitor. However, entries are made by the customer using a scanner, keypad and/or a touch screen, instead of by a store employee.

As a result of the adoption of these innovations, many supermarkets and other retail establishments now have an area of the store that includes a plurality of checkout terminals with monitors that are placed in a conspicuous location, such as adjacent the store entry and/or an aisle way used by prospective customers, such as when entering the store. Often, at least some of these terminals are temporarily unused.

The present invention takes advantage of this fortuitous proximity by displaying selected advertising materials within graphical fields on the screens of these checkout monitors as the graphical fields become available. More specifically, the present invention provides a method of displaying advertising materials, such as product images within one or more graphical fields of a checkout monitor screen during periods of checkout terminal inactivity or after the relinquishing of one or more graphical fields used by existing software during normal operation. In the case of checkout terminal inactivity, a graphical field may take up the area of an entire monitor screen allowing the database to be presented as a tradition screensaver. On the other hand, during normal operation of existing software applications such as those used to “checkout” a customer, graphical fields smaller than the entire screen may become available from time to time. As such, any available graphical fields may be used to display one or more presentation graphics in a fixed or random sequence. Moreover, the graphical fields may be displayed by a “split screen” based software application that displays a static graphic or random graphic that may or may not be included in a screen saver during inactivity of a checkout terminal.

Generally, the present invention includes the steps of selecting advertisements to be displayed electronically, compiling a database comprised of the selected advertisements, and displaying the database as a sequence of presentation graphics within at least one graphical field on each of one or more checkout terminal monitor screens. The sequence of presentation may be random or fixed. At some times, where the software does not allow a windows based screen saver, an executable program can be installed to override the software during periods of inactivity to display graphical advertisements whether this is initiated by the terminal operator or by default inactivity programmed to begin after a predetermined length of inactivity. Additional steps may be included in the method, depending on the manner in which these steps are implemented.

In one embodiment of the invention, the store enters into agreements with various product suppliers, the term being used herein to include manufacturers, intermediaries between the manufacturer and retailer, and advertising agencies and other entities acting on behalf of manufacturers or such intermediaries, to advertise selected products during a specified time period on the screens of checkout monitor terminals in one or more retail establishments managed by the retailer. The retailer then compiles, or contracts with a third party to compile a database of advertising material and other product information relating to the selected products, e.g., images of the products with price points and effective dates. These images are then stored on a server as a presentation graphics database, and transferred to one or more graphical fields on a monitor screen during the specified time period during periods when the monitors are otherwise unused.

For example, the advertising material can be stored in a server or terminal connected by a local area network or LAN to the checkout terminal, so that the advertising material is displayed within at least one graphical field on the checkout terminal monitor screen whenever at least one graphical field becomes available including when the monitor screen has been inactive for a given period of time. If the advertising materials are only to be displayed on one terminal, the software database can be transferred to the hard drive of the checkout terminal.

Alternatively, an advertising material supplier or compiler can prepare a presentation graphics database comprised of selected information corresponding to products to be advertised in accordance with agreements reached with product suppliers. The compiler can then provide a copy of the database to a store, or to a plurality of stores, for display on checkout terminal monitors, paying the store or stores for the opportunity to display the material, while collecting advertising fees from the suppliers.

The selected database may be comprised of graphic images of the products offered. These images may be obtained, for example, from a master database containing a large number of graphic product images provided by manufacturers for advertising purposes. An example of a master database that can be used for this purpose is the Kwikee Systems database, of Multi-Ad Services, Inc. Alternatively, still or animated advertisements can be assembled into one software display for sequential or random display of the advertising materials as a screen saver, graphical fields, or executable program.

The database is compiled using screen saver or presentation graphics software, various other third-party software programs, and proprietary software developed by providers of graphical displays. Also, various commercial software programs are available that allow adding images, e.g., in EPS, GIF, JPEG or TIFF format, to a database. These programs allow a user to select the time and other parameters to be used in displaying the images. Some or all of the images may be animated. The presentation graphics program may also include music, announcements, or other recorded sounds to be played with the display of the images. The compiled presentation graphics program can be saved, e.g., as a .scr file, or an executable file. For example, the presentation graphics program may be a standard screen saver or it can be an executable program such as PowerPoint™ presentation packaged with a PPT viewer, and a batch file.

If the program or database is complied in-store, the program or database can be saved on the store server, with the selected checkout terminals being programmed to display the database by way of a screen saver, graphical fields or executable program after a predetermined period of inactivity. If the program is compiled at a remote location, such as at the location of an independent compiler, the completed program or database can be transferred electronically to the store, e.g., by email or over the Internet, or sent to the store on a disc or CD.

### BRIEF DESCRIPTION OF THE DRAWINGS

FIG. 1 is a schematic of a first embodiment of the invention.

FIG. 2 is a schematic of a second embodiment of the invention.

FIG. 3 is a schematic of a third embodiment of the invention.

FIG. 4 is a perspective view of a checkout terminal displaying more than one graphical field on its monitor screen.

FIG. 5 shows the checkout terminal of FIG. 4 displaying a graphical field taking up the entire monitor screen.

### DETAILED DESCRIPTION OF THE INVENTION

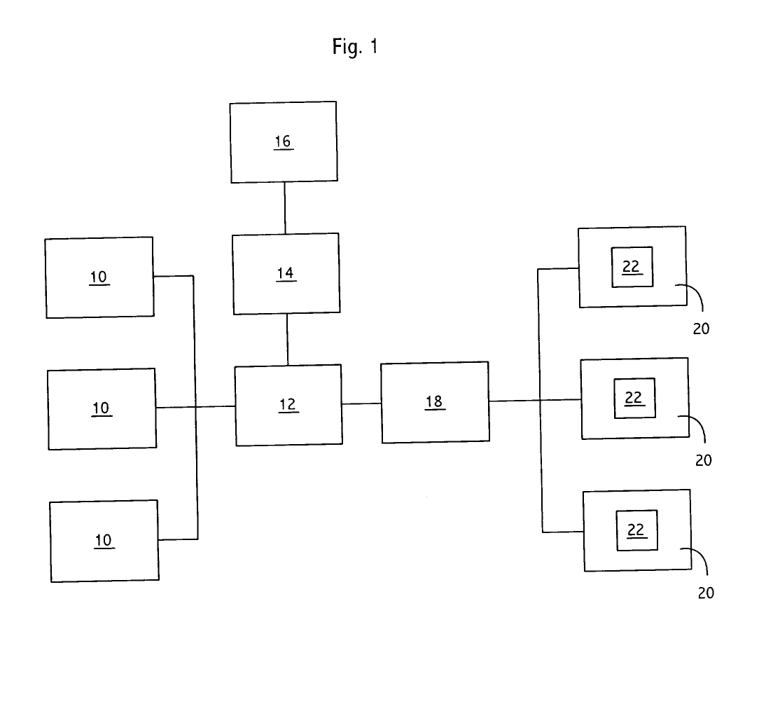

FIG. 1 illustrates an embodiment of the invention in which selected advertisements are identified in communications between one or more suppliers 10 and store 12. The list of selected advertisements is then provided to an independent entity, referred to as a compiler 14, who acquires images or other advertising materials from one or more internal or external databases 16. Compiler 14 then assembles the acquired advertising materials into a presentation graphics database for a screen saver, or graphical fields controlled by an executable program that is transmitted to store 12. Store 12 then stores the program on a server 18 within the store's computer system, where the program is accessed by one or more terminals 20 for display on the terminal monitor 22.

It will be appreciated that the number of suppliers and/or the number of terminals may be different than illustrated. Also server 18 may be a dedicated CPU or other data storage device, e.g., the hard drive of a computer used by the store manager.

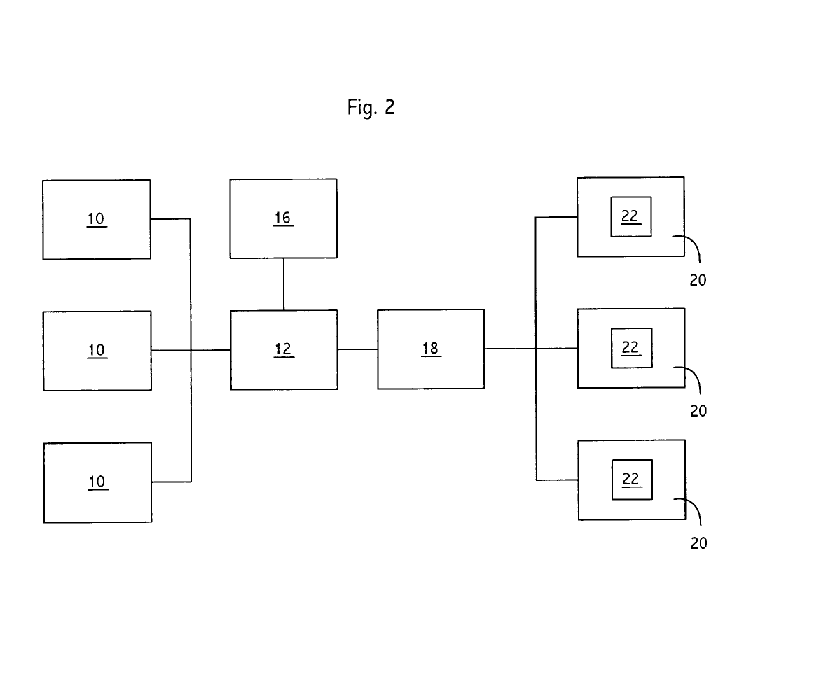

FIG. 2 illustrates another embodiment of the invention in which the screen saver is compiled internally by store 12. In this embodiment, like the preceding embodiment, store 12, in communication with suppliers 10 selects products to be advertised. Store 12 then assembles images or other advertising materials from one or more databases 16, and compiles the advertising materials into a presentation graphics database for a screen saver or graphical fields controlled by an executable program for storage on server 18 and display on monitors 22 of checkout terminals 20.

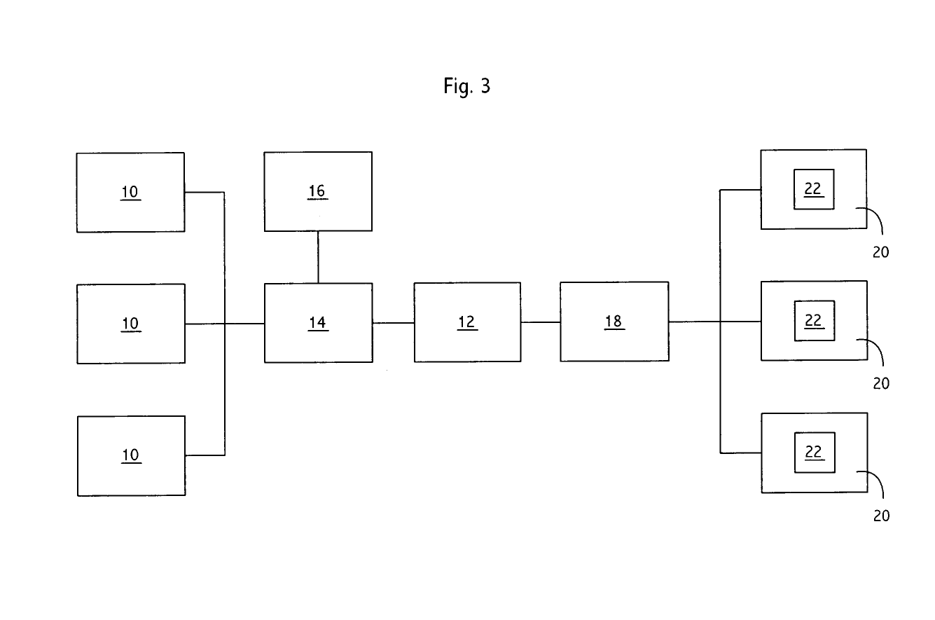

In a third embodiment of the invention illustrated in FIG. 3, compiler 14 communicates with product suppliers 10 to select products to be advertised. Compiler 14 then selects images or other advertising materials from databases 16, and assembles the materials into a presentation graphics database for a screen saver or graphical fields controlled by an executable program, which is provided to stores 12 for storage on server 18, and display on terminals 20 of monitors 22.

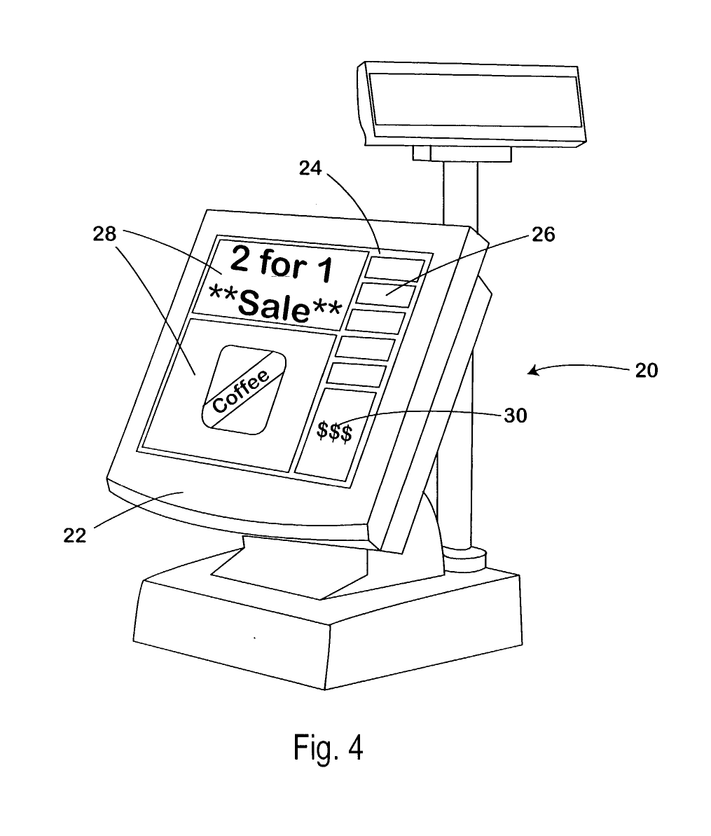

FIG. 4 shows a perspective view of a typical checkout terminal, generally 20. Terminal 20 has a monitor 22 and a screen 24. Screen 24 can be touch sensitive allowing a user to generate input to terminal 20 by touching regions on screen 24 highlighted by interface graphical fields 26. Other graphical fields 28 can be used concurrently to display presentation graphics from a database of advertising materials. Furthermore, graphic fields 26 can become available for presentation graphics 30 as an existing program for terminal 20 relinquishes display resources.

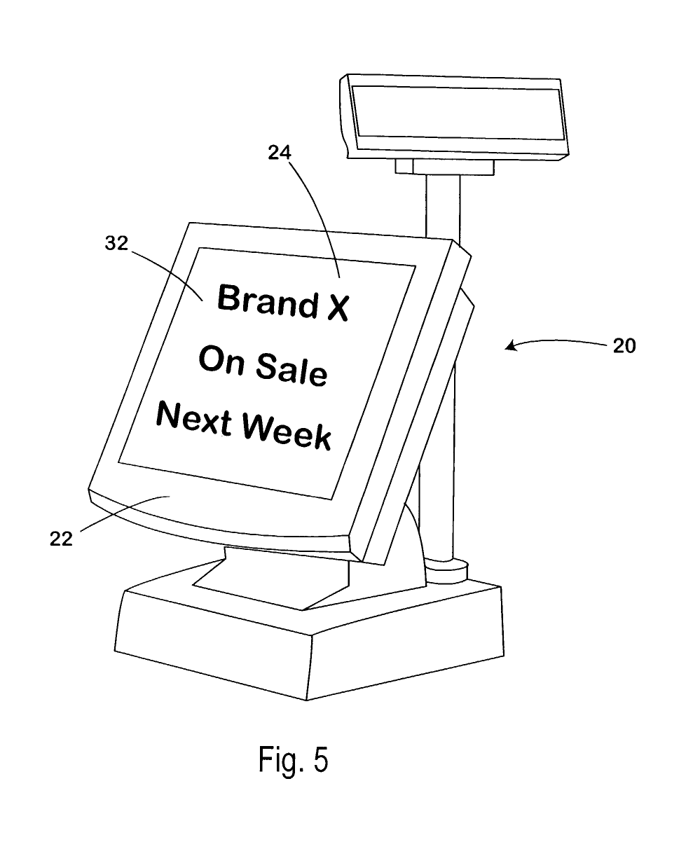

FIG. 5 shows monitor 22 of terminal 20 displaying a single graphical field 32 taking up the entire area of screen 24. Graphical field 32 may be animated to serve as a screen saver for monitor 22.

Thus, the method of the present invention provides an additional opportunity for manufacturers and other product suppliers to advertise their products at the point of sale, while providing retailers with an opportunity to generate revenue from an unused resource; namely, the monitors of inactive checkout terminals or graphical fields controlled by software.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method of electronically displaying product information to prospective purchasers in a retail establishment comprising:
a) providing a plurality of checkout terminals with monitors having at least one graphical field, wherein said at least one graphical field is viewable by prospective purchasers in said retail establishment;
b) identifying a plurality of products to be displayed;
c) compiling a selected database of product information corresponding to said identified products; and
d) displaying said selected database as a sequence of presentation graphics on said checkout terminal monitors at times when said at least one graphical field is available.

2. The method of claim 1, wherein said product information comprises advertisements including product images.

3. The method of claim 1, wherein said retail establishment is selected from the group consisting of supermarkets, department stores, specialty stores, automotive stores, and hardware stores.

4. The method of claim 1, wherein said selected database is compiled from a master database.

5. The method of claim 1, wherein said plurality of products is identified by a first party and said selected database is compiled by a second party.

6. The method of claim 1, wherein said plurality of terminals are part of a local area network that includes a control terminal, said at least one graphical field for each of said monitors being controlled from said control terminal.

7. The method of claim 1, wherein said products are packaged goods and said advertisements are graphic images of said products.

8. A method of electronically providing information about a plurality of products in a retail establishment for a given time period comprising:
a) identifying a plurality of products offered by suppliers;
b) compiling a software database of information corresponding to said products;
c) receiving said database from said compiler; and
d) displaying said database within at least one graphical field on at least one checkout terminal monitor viewable in said retail establishment by prospective customers during said given time period.

9. The method of claim 8, wherein said information includes advertisements having price points and effective dates.

10. The method of claim 8, wherein said retail establishment is selected from the group consisting of supermarkets, department stores, specialty stores, automotive stores, and hardware stores.

11. The method of claim 8, wherein said selected database is displayed within at least one graphical field as a screen saver when said terminal is not in use.

12. The method of claim 8, wherein said plurality of products is identified by a first party and said selected database is compiled by a second party.

13. The method of claim 8, wherein said plurality of terminals are part of a local area network that includes a control terminal, said at least one graphical field for each of said monitor screens being controlled from said control terminal.

14. The method of claim 8, wherein said products are packaged goods and said information includes advertisements with graphic images of said products.

15. A method of advertising selected products to prospective purchasers in a retail establishment having at least one checkout terminal with a monitor screen having at least one graphical field viewable by said prospective customers comprising:
a) selecting information for said products;
b) storing the selected information as a database of electronic images; and
c) displaying the selected information within said at least one graphical field on said monitor screen.

16. The method of claim 15, further including the step of electronically transmitting said database to said retail establishment.

17. The method of claim 15, wherein said images are displayed on said monitor screen within said at least one graphical field whenever said at least one graphical field is otherwise inactive.

18. The method of claim 15, wherein said information is advertising material includes images of said products.

19. The method of claim 15, wherein at least a part of said information is animated.

20. The method of claim 15, wherein said at least one checkout terminal is part of a local area network including a control terminal, the display of said database being controlled from said control terminal.

21. A method of electronically providing information about a plurality of products in retail establishments for a given time period comprising:
a) selecting products offered by a plurality of suppliers;
b) compiling a software database of information corresponding to said products; and
c) displaying said database within at least one graphical field on checkout terminal monitor screens in a plurality of retail establishments, said monitor screens being viewable in said retail establishment by prospective customers during said given time period.

22. The method of claim 21, wherein said information comprises advertising material includes images of said products.

23. The method of claim 21, wherein said retail establishments are selected from the group consisting of supermarkets, department stores, specialty stores, automotive stores, and hardware stores.

24. The method of claim 21, wherein said suppliers are manufacturers.
